(19) United States
(12) Patent Application Publication
(10) Pub. No.: US 2011/0166971 A1
(43) Pub. Date: Jul. 7, 2011

(54) Electronic Delivery of Paper Paychecks

(76) Inventor: Ashraf Ghazali, Houston, TX (US)

(21) Appl. No.: 12/651,563

(22) Filed: Jan. 4, 2010

(51) Int. Cl. G06Q 40/00; G06Q 10/00

(52) U.S. Cl. 705/32; 705/45

(57) ABSTRACT

A method and system for delivering paper paychecks electronically, such as web-link download or email attachment using internet. The Payroll processing companies receive the periodic payroll information of employees via fax, email or web-link upload from the employer and encoded that information into their payroll software for preparing the paychecks. The paychecks are then transformed into a rich text format, PDF or any other format like Microsoft Word which is widely and commonly used computer application and uploaded those transformed paychecks either at the designated web-link for download by the employers or attach them with the email for their printing by the employer on the blank preprinted checks. Extreme mobility of having paper paychecks electronically anywhere and controlling of payroll funds can be achieved by using this method.

### BACKGROUND

1. Technical Field

Employers under the present payroll processing method are either uploading their periodic employees payroll information to their assigned accounts with the payroll processing companies or sending faxes to them or emailing them the periodic employees payroll information for receiving the completed paper paychecks which are either mailed to the employers for further distribution to their employees or to the employees directly by the payroll processing companies at their respective individual addresses. Some of the payroll processing companies also transfer the funds directly to the bank accounts of the employees. Under all the existing methods of payroll processing, paychecks are neither uploaded on the designated web-link nor are attached to the email for printing by the employers themselves on the pre-printed blank checks. By uploading the completed and full functional paychecks on the designated web-link or sending the paychecks via email attachment to those employers who prefer to receive the physical paychecks, the chance of mail loss and the non-delivery due to any known or unknown reason, can be completely eliminated and the employers are free to receive the paychecks electronically anywhere and print them for their employees by using widely accepted software like Microsoft Word, PDF or any other software applications which is commonly used by the general public who are using the computers for daily use, without having any payroll software and subscription.

The payroll processing companies under the existing methods debit the employers bank account immediately for the funds attributed to the employees' paychecks and deposit the proceed into their own bank accounts for enjoying the benefits of holding those funds until the paychecks are presented by the employees into the payroll processing companies' banks.

It is therefore apparent that there exists a need in the art for delivering paychecks to the employers who can not only receive the employees' paychecks anywhere electronically but also print the paychecks on pre-printed blank check papers without any payroll software application or subscription. Besides, the employer should have a right to enjoy the full benefits of keeping their own funds until the paychecks are presented in their own banks.

### SUMMARY

In one embodiment, the present invention solves the problems of receiving the paychecks via physical mail like loss in mail or non-delivery due one or more reason.

In one embodiment, under the method of present invention, the payroll processing companies who are maintaining the paycheck preparation software, convert the paycheck images into rich text format, PDF format or any other format which is also widely available to the general public who are using the computers for daily use, and upload them at the assigned web-link account of the employers or attach them with the email to the employers.

The employers can receive the paychecks electronically anywhere and print them on the pre-printed pre-numbered blank checks without any payroll software and subscription.

The employers will be using their own bank account for the paychecks and enjoying the benefits of holding the funds until the employees present the paychecks into the employers' own bank.

In one embodiment and under the method of present invention, employer receiving the paychecks electronically can be the cost effective method for the employers and unnecessary cost of mailing will be reduced.

In one embodiment and under the method the present invention, the payroll processing companies can have any kind of software to prepare the paychecks but must have an ability to convert the paychecks into a rich text format, PDF format or any other format which is widely available to the general public who are using the computers for daily use.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is the view of blank check of the employer's bank;

FIG. 2 is the view of a full functional transformed paycheck into a rich text format without the check number therein and any information required by the bank to honor the paycheck, according to one embodiment of this invention;

FIG. 3 is the view of transformed image of paycheck in rich text format or PDF format issued by the payroll processing company on the pre-printed pre-numbered blank check of the employer's bank, according to one embodiment of this invention according to one embodiment of this invention;

FIG. 4 is the view of Web-link of the employers to download the completed paychecks according to one embodiment of this invention;

FIG. 5 is the view of email attachment to download the completed paychecks according to one embodiment of this invention.

### DETAILED DESCRIPTION

According to the embodiments described herein, electronic delivery of paper paychecks can be made. That is, the paycheck with a plain background without any bank information can be downloaded from an assigned web-link account of the employer or from an email attachment for printing them onto a blank pre-printed check papers.

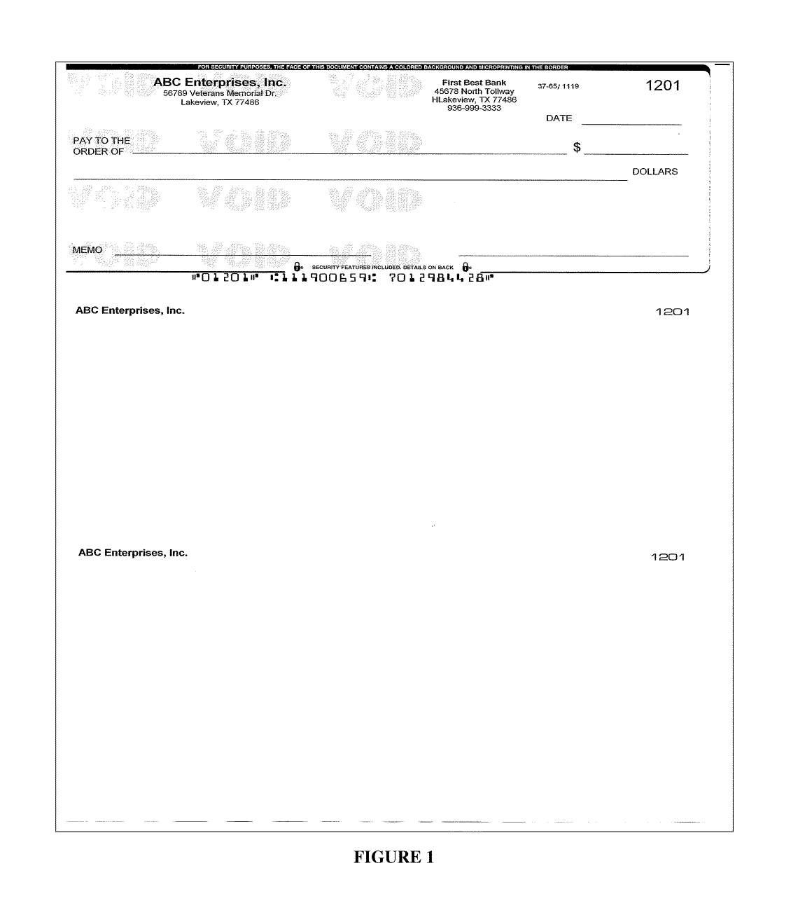

As illustrated in FIG. 1, the pre-printed pre-numbered regular blank check has necessary information of the employer and the bank to honor the check upon presentation. The pre-printed pre-numbered regular blank check is printed on a security bonded paper and is required to be filled by the employer for the employee or any other beneficiary. In order to get the payroll details, the check will be necessarily of voucher style but optionally in various layouts compatible with widely accepted software like Microsoft Word, PDF or any other software applications which is commonly used by the general public who are using the computers for daily use, without having any payroll software and subscription.

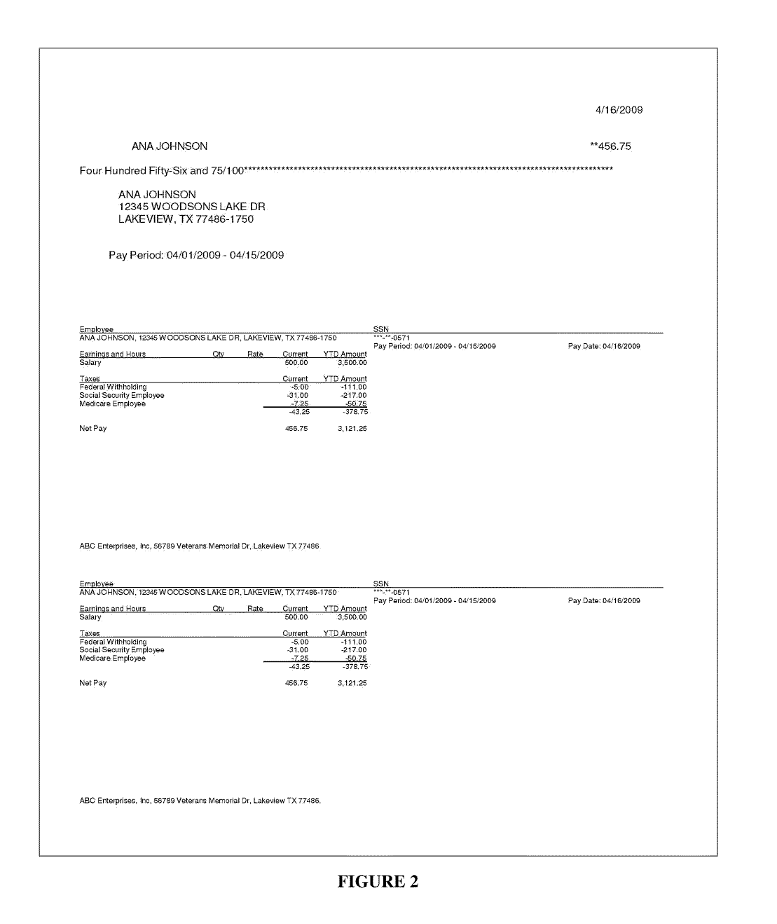

As illustrated in FIG. 2, the paycheck has only the payroll details of the employees. This is an image of electronic paycheck of an employee without the check number and any information required by the bank to honor the paychecks and has no background information texture. This image of paycheck is printed on a pre-printed pre numbered check made of security bonded paper with full bank information of the employer.

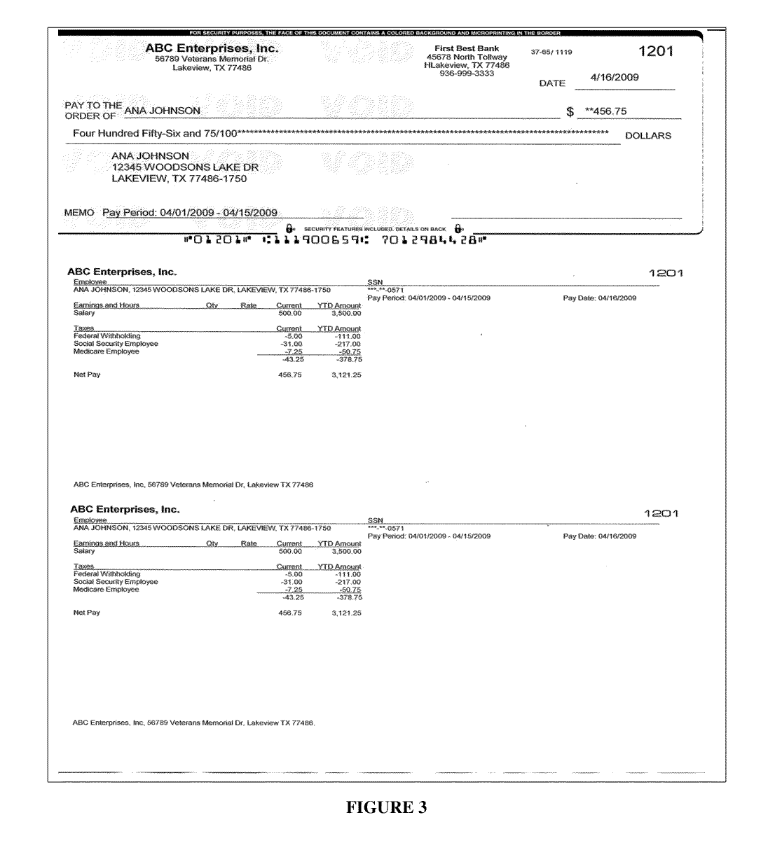

As illustrated in FIG. 3, the paycheck has complete payroll details of the employee and full bank information of the employer. The paycheck is prepared by printing an image of electronic paycheck of an employee without the check number and any information required by the bank to honor the paycheck, on a pre-printed pre-numbered check made of security bonded paper with full bank information of the employer.

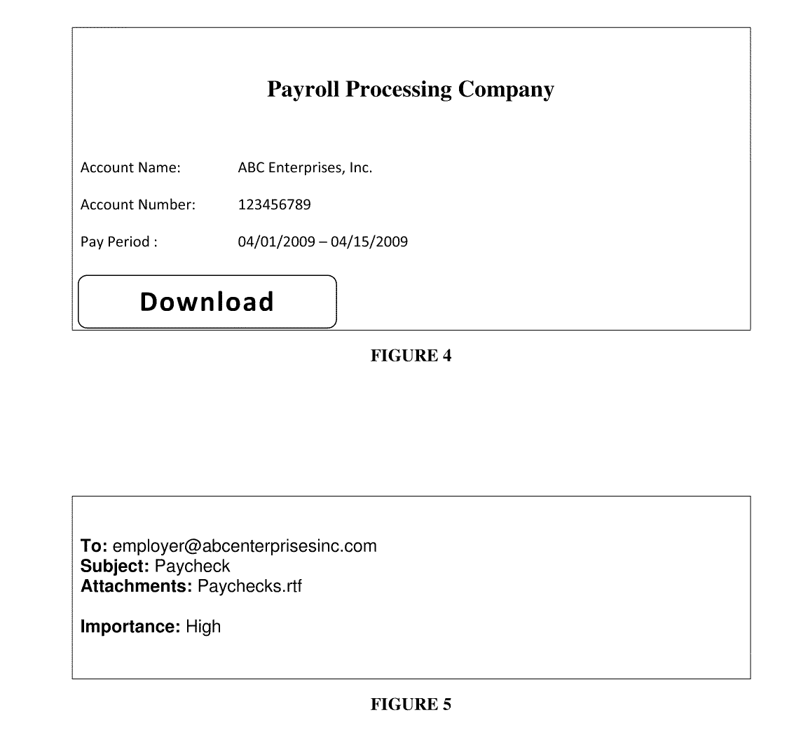

As illustrated in FIG. 4, the paychecks are ready to download into a employers computer.

As illustrated in FIG. 5, the paychecks are attached to the email of the employer.

The invention claimed is:

1. A method of delivering paper paychecks electronically to the employers, by the payroll processing companies, comprising:
uploading the downloadable images of the full functional paychecks without the check numbers and any information required by the bank to honor the paychecks, by the payroll processing company, on the web-link of the employers' accounts assigned by the payroll processing company;
attaching the downloadable images of the full functional paychecks without the check numbers and any information required by the bank to honor the paychecks, with the email to the employer by the payroll processing companies;
downloading the uploaded or attached images of the full functional paychecks without the check numbers and any information required by the bank to honor the paychecks, by the employers either from the web-link of the employers' accounts assigned by the payroll processing company or from the email sent by the payroll processing company to the employers, respectively, in rich text format, PDF format or any other format which is also widely available to the general public who are using the computers for daily use;

2. A method of delivering paper paychecks electronically in claim 1, where the method comprises the act of:
receiving the images of full functional paychecks without the check numbers and any information required by the bank to honor the paychecks by the employers electronically anywhere, where the internet connection is available.
receiving the images of full functional paychecks without the check numbers and any information required by the bank to honor the paychecks by the employers electronically by using the software applications like Mircosoft Word, PDF or any other software applications which is widely used by the general public who are using the computers for daily use.

3. A method of delivering paper paychecks electronically in claim 2, where the method comprises the act of:
printing the paychecks by the employers for their employees on blank pre-printed pre-numbered bank checks with the desired margin and font settings.
printing the paychecks on blank pre-printed pre-numbered bank checks without any special ink or software.

4. A method of delivering paper paychecks electronically in claim 3, where printing on blank pre-printed pre-numbered bank checks comprises:
regular printer with regular ink. regular text fonts with the desired margin.

5. A method of delivering paper paychecks electronically in claim 1, where the method comprises the act of:
keeping the bank funds by the employers until the paychecks are presented into the bank by the employees.
